(19) United States
(12) Patent Application Publication
(10) Pub. No.: US 2006/0051720 A1
(43) Pub. Date: Mar. 9, 2006

(54) Apparatus and process for the treatment of materials

(76) Inventors: James F. Jarrell, Dexter, MO (US); James F. Jarrell II, Dexter, MO (US)

Correspondence Address: W. EDWARD RAMAGE, COMMERCE CENTER SUITE 1000, 211 COMMERCE ST, NASHVILLE, TN, 37201, US

(21) Appl. No.: 10/933,747

(22) Filed: Sep. 3, 2004

(51) Int. Cl. F27B 9/02

(52) U.S. Cl. 432/128

(57) ABSTRACT

A method and apparatus for separating a material into its organic and inorganic components are disclosed. The material is heated under negative pressures in the presence of a minimal amount of oxygen to separate into vapor and solid phases. The vapor phase is removed and cooled, and the solid phase is removed and processed. Depending on the material being treated, the method and apparatus can produce fuel and commercial products. The methods and apparatus of the present invention produce little or no air emissions and conserve energy.

### FIELD OF INVENTION

This invention relates to an apparatus and process for the treatment of materials. In a more specific aspect, this invention relates to an apparatus and process for the treatment of materials in which such materials are separated into their organic and inorganic components. As used in this application, the term “material(s)” is intended to refer to various items which are capable of being separated into their organic and inorganic components, including, but not limited to, plastics, garbage, soil, non-living animals, rubber, and tires.

### BACKGROUND OF INVENTION

Incineration and burying have been used in the past as the primary means of disposing of various materials that are no longer useful. Under the continuing and increasingly strict environmental standards of today, however, incineration and burying have been less favored and even prohibited. Incineration is prohibited in many locations due to air pollution concerns, for example.

The prior art contains processes to heat various materials under negative pressure in order to reduce their volume and/or separate components. Depending on the material(s) involved, some of the separated components recovered may have commercial value. One common example of such materials are rubber tires, which can be heated under pressure to produce hydrocarbon and carbonaceous components. The conversion of rubber into fuels is generally known. Examples of such prior art include Herbold et al., U.S. Pat. No. 4,084,521; Chambers, U.S. Pat. No. 4,235,676; Solbakken, et al., U.S. Pat. Nos. 4,250,158 and 4,284,616; and Roy, U.S. Pat. No. 4,740,270.

For various reasons, however, the processes and related apparatus disclosed in the prior art have several disadvantages, including the inability to produce liquid hydrocarbons with low sulfur content, the presence of significant fire and explosion risks, and high levels of emissions and secondary wastes. Several of these problems were addressed in Jarrell, U.S. Pat. No. 5,230,777, which disclosed an apparatus with two sealed processors for the heating of rubber tires. However, that apparatus may not be as efficient in treating rubber tires as demanded by today's environmental standards and higher energy costs. Moreover, the processes and related apparatus disclosed in the prior art generally have not been successfully used in treating materials other than rubber tires. Thus, what is needed is a process and related apparatus for treating and separating various materials into their organic and inorganic components in a cost-effective and energy-efficient manner.

A process and apparatus have now been developed that overcomes the above-noted problems and also has numerous other advantages that will be apparent to those skilled in the art.

### SUMMARY OF THE INVENTION

The present invention provides an apparatus and process for treating various materials to separate said materials into their organic and inorganic components. Depending on the materials being so treated, the organic and inorganic components recovered may be useful in further applications. One object of this invention is to provide such an apparatus and process where the organic and inorganic components recovered are of better quality and higher value than the prior art. Another object of this invention is to provide such an apparatus and process where the amount of energy used to treat the materials is substantially less than in the prior art.

In one exemplary embodiment, the invention comprises heating a material in at least one sealed processor, with an internal radiant tube, at a temperature of about 100 to 1000 degrees F., under pressure of about 25.0 to 759 mm Hg absolute, for a reaction time sufficient to cause the material to dissociate into its organic and inorganic components. One or more of the components may be present in a vapor phase, which can be removed in whole or in part from the processor in the form of a vapor stream and subsequently condensed in whole or in part. Condensing may be accomplished by means of a serpentine cooling apparatus. Similarly, one or more of the components may be present in solid phase, which can be removed and processed. Preferred temperature ranges are from about 300 to 700 degrees F., and more preferably about 400 to about 500 degrees F. Preferred pressure ranges are from about 316 to about 625 mm Hg absolute, more preferably about 366 to about 618 mm Hg absolute, even more preferably about 416 to about 568 mm Hg absolute. Preferred reaction time is approximately 1 to 5 hours, preferably about 2 to 4 hours, and especially preferably about 3 to 3.5 hours, depending on the material being heated. The reaction alternatively can be precisely determined based on reduction in weight of the material being treated.

In another exemplary embodiment, the material being treated is loaded on one or more racks comprising one or more trays. The racks may be wheeled, and when connected in sequence, moved into and out of the processor together by means of a winch or similar device.

In another exemplary embodiment, the processor is cylindrical, with material being agitated or mixed by an auger or similar means inside the processor during the treatment process. Material may be loaded through doors in the top of the processor, and removed through doors in the bottom of the processor.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a schematic flow diagram illustrating a preferred embodiment of the apparatus and process of the present invention, in which a single processor is shown for processing materials in accordance with the present invention.

FIG. 2 is a side view of a single processor in accordance with the present invention.

FIG. 3 is a cutaway side view of the single processor with a single serpentine radiant tube illustrated in FIG. 2.

FIG. 4 is a schematic flow diagram illustrating the heating system for the single processor illustrated in FIG. 2.

FIG. 5 is a schematic flow diagram illustrating the vapor collection and condensing system for the single processor illustrated in FIG. 2.

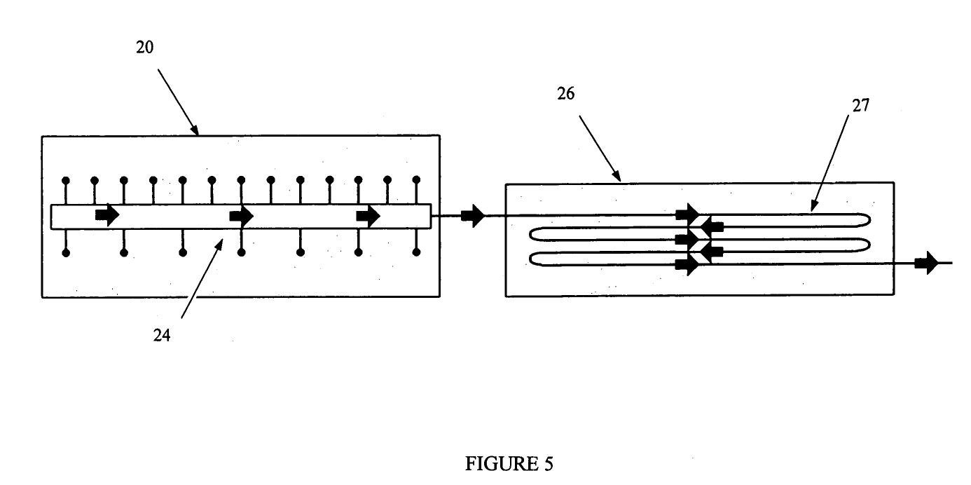

FIG. 6 is a side view of a single processor in cylindrical form.

FIG. 7 is a top view of the processor illustrated in FIG. 6.

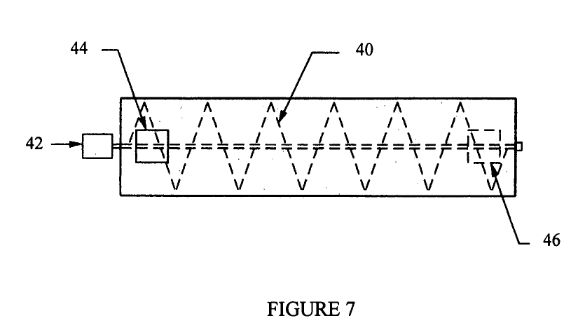

FIG. 8 is an end view of the processor illustrated in FIG. 7.

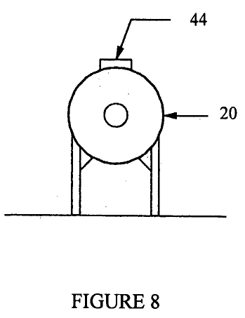

FIG. 9 is a top view of a pair of processors linked in parallel in accordance with the present invention.

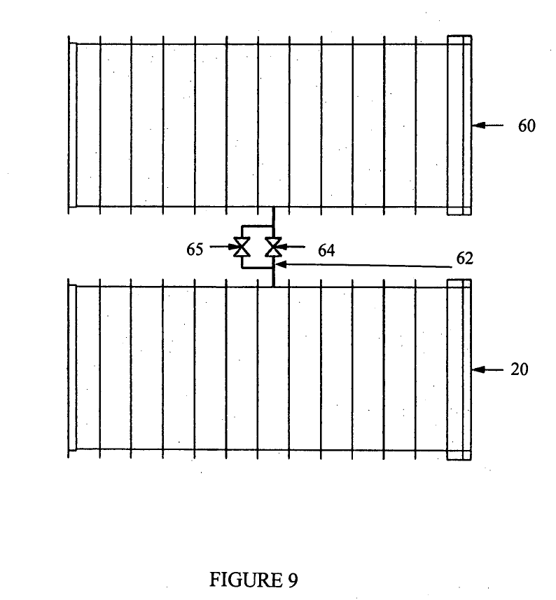

### DETAILED DESCRIPTION OF THE INVENTION

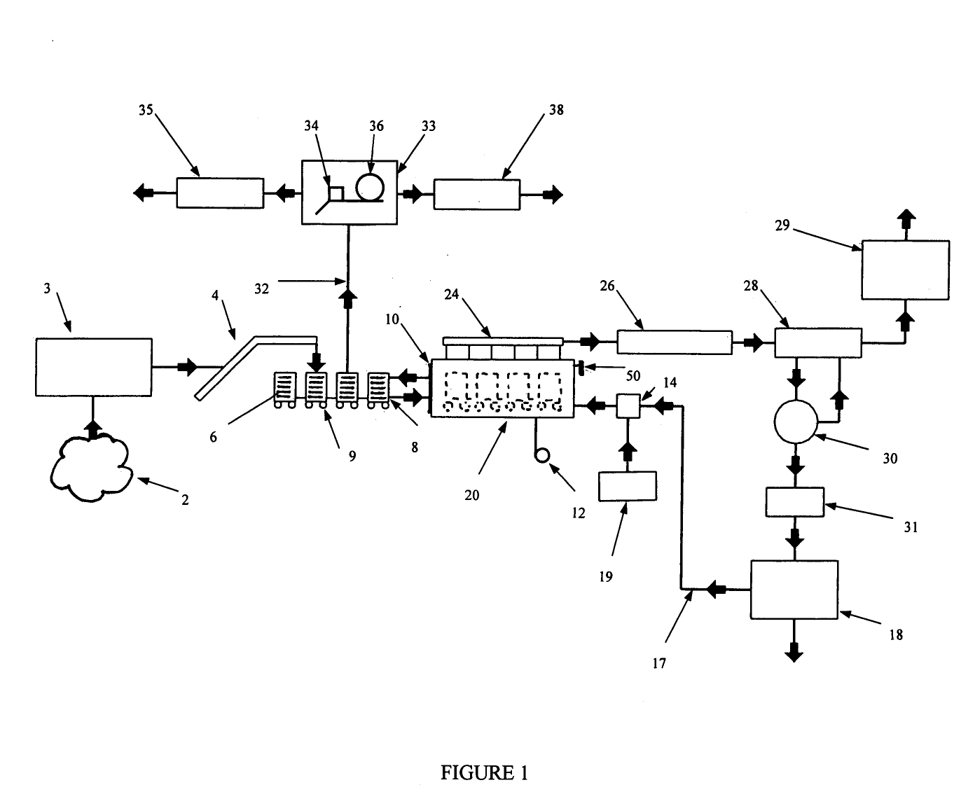

As illustrated in FIG. 1, the material 2 to be treated is brought to a receiving area 3. The receiving area may be enclosed and of a variety of sizes or configurations, depending upon the material 2 to be treated and the size of the processing operation. The material 2 may be treated or reduced before being processed by the present invention, although reduction or pre-treatment is not necessary. One advantage of the present invention is that reduction or pre-treatment of the material 2 is not required and the material may be processed in the form in which it is received.

After pre-treatment or reduction, if any, the material 2 may be stored for later processing, or sent directly for processing by the processor 20 of the present invention by any suitable means, such as a wide apron conveyor 4. If storage is desired, transportation to a storage area may be accomplished by any suitable means.

In an exemplary embodiment, the material 2 is placed on one or more trays 6, which are then loaded on one or more racks 8. Alternatively, the material 2 can be placed on trays 6 which are already loaded on racks 8. The trays 6 and racks 8 facilitate loading and unloading of the processor 20. Use of the trays 6 and racks 8 also tends to increase processing efficiency by distributing the material 2 and thereby increasing reaction surface area. A rack 8 may be of any suitable configuration depending upon the dimensions of the processor 20 being used. In one exemplary embodiment, a single rack 8 has six trays 6, the trays spaced vertically approximately 30.5 cm apart and each tray capable of holding 345.5 kilograms.

The material may be weighed before being placed on the trays 6 and racks 8, by means such as a weigh belt. One or more racks 8, when filled, are loaded into the processor 20. Loading can be accomplished by suitable means, such as a forklift. Alternatively, the racks 8 may have wheels 9, and thus may be moved into and out of the processor 20 by suitable means, such as one or more winches. In one exemplary embodiment, one or more racks 8 may be linked together in series, and the racks 8 then moved into and out of the processor 20 together. Rails designed to accommodate the wheels 9 of the racks 8 may be used to facilitate the movement of the racks 8 into and out of the processor 20. The number of racks that may be linked in series depends on the length of the processor 20. Similarly, the height and width of the racks, the size of the trays, and the number of trays contained on each rack depends on the height and width of the processor 20.

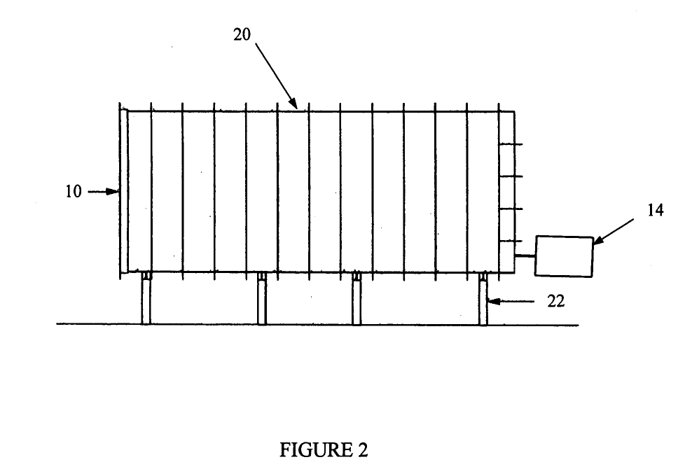

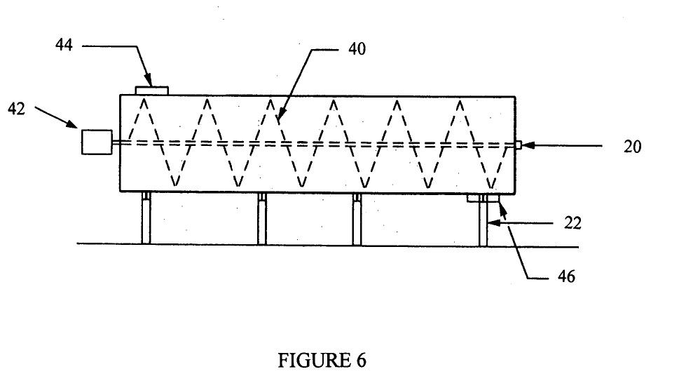

The processor 20 may be of any suitable configuration and construction. As shown in FIG. 2, one exemplary embodiment is a rectangular box, although as shown in FIG. 6 the processor may also be a cylinder. The processor may be fixed in place, or of a size where it is portable. In one exemplary configuration, the processor is a rectangular box of approximately 2.9 m×2.9 m×6.1 m. In another exemplary configuration, the processor is a rectangular box of approximately 10 feet×10 feet×50 feet. The processor 20 must be capable of withstanding an internal pressure of from about 25.0 to about 759 mm Hg absolute, and an internal temperature of from about 100 degrees F. to about 1000 degrees F. In another exemplary embodiment, the processor 20 is constructed from steel, preferably ribbed reinforced steel. The processor 20 may also be insulated, to increase efficiency and reduce run times.

After the rack or series of racks 8 is loaded into the processor 20, the processor is sealed. Sealing may be accomplished by any suitable means, such as bolting the processor door 10. In one exemplary embodiment, the processor door 10 is double sealed with a primary and a secondary gasket. Alternatively, such a double sealing system may be further provided with multiple stainless steel rods operated by compressed air cylinders so that said rods act against the processor door 10 to provide an even stronger seal.

After sealing, a negative pressure is drawn in the processor 20, resulting in an internal pressure of approximately 25.0-759 mm Hg absolute. Pressure may be drawn by suitable pressure-reducing means known in the art, such as a vacuum pump 12. The sealed processor 20 does not allow significant amounts of air leakage into the processor 20. In one exemplary embodiment of the present invention, the allowable amount of air leakage per hour is an average of less than about 3.0 weight percent air as compared to all vapors and gasses in the processor 20, preferably less than about 1.5 weight percent, especially preferably less than about 0.5 weight percent, and in yet more preferred embodiments less than about 0.05 weight percent or even 0.00 weight percent.

An absence of oxygen in the processor 20 is defined as an amount of oxygen that results when the average amount of air entering the processor per hour is less than about 3.0 weight percent air as compared to all vapors and gasses in the processor 20, preferably less than about 1.5 weight percent, especially preferably less than about 0.5 weight percent, and in yet more preferred embodiments less than about 0.05 weight percent or even 0.00 weight percent.

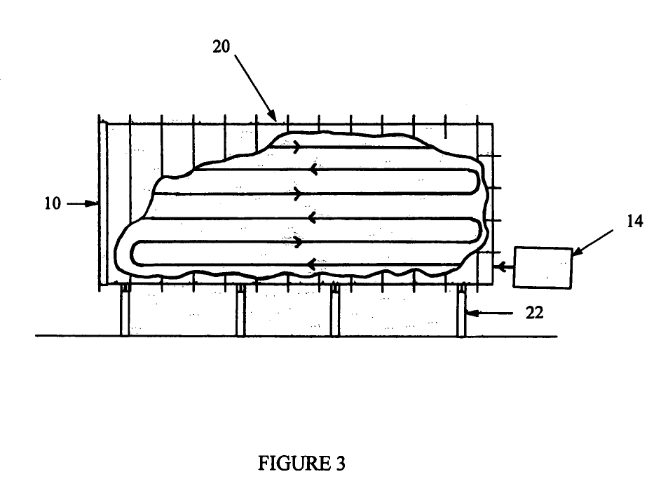

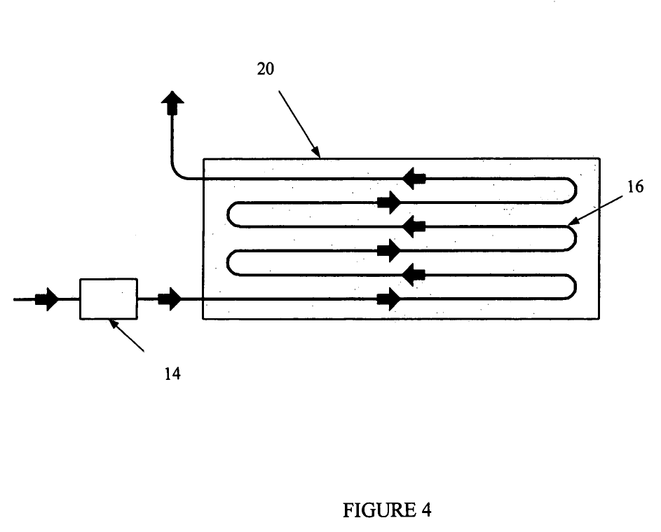

As shown in FIGS. 1 and 3, at least one burner 14 is used to heat the contents of the processor 20 by means of a radiant tube 16 located inside the processor 20. In one exemplary embodiment, a single burner 14 heats a single radiant tube 16. The radiant tube 16 may be serpentine in form, as shown in FIGS. 3 and 4, to increase heating efficiency. The burner 14 may be located near or adjacent to the processor 20 in a convenient position, depending on the configuration of the radiant tube 16. The burner 14 may be fueled by methane or the like, either from stored gas produced as an end product from the instant process 18 or from an auxiliary gas supply 19, or both. In an exemplary embodiment, a blower system introduces an air/fuel mixture through fuel lines 17 to the burner of approximately 70% air and 30% manufactured gas or natural gas, including but not limited to propane or methane. In a preferred embodiment, the burner is fueled by products of the process of the present invention, such as gaseous hydrocarbons. Depending on the material being treated, the burner 14 may be fueled only by products of the process of the present invention 18, with no outside fuel source 19.

In one exemplary embodiment, the processor 20 and its contents are heated to an interior temperature of from about 100 to about 1000 degrees F., preferably from about 300 to 700 degrees F., and more preferably about 400 to about 500 degrees F. Although not limiting the invention, depending on the material being treated, the internal temperature should not rise about 725 degrees F. for a prolonged period. This is particularly so if the material is rubber, because at temperatures about 725 degrees F. sulfur in the rubber will gasify, resulting in a higher sulfur content in the vapor produced during the process. Heating continues for a reaction time of approximately 1 to 5 hours, preferably about 2 to 4 hours, and especially preferably about 3 to 3.5 hours. Reaction time for purposes of this application means the amount of time the material is heated in the processor. In an exemplary embodiment, the application of heat during the treating process is controlled by an automatic control system 50 or similar means. The automatic control system 50 can precisely determine the amount and length of heating needed for the material being treated, and terminate the application of heat at an appropriate point.

In an exemplary embodiment, the invention is able to measure and monitor the weight of the material 2 on the trays. This may be through weighing means incorporated into the racks 8, or by scales 22 which weigh the processor and all contents. As the material 2 is heated and broken down into its organic and inorganic components, the weight of the material 2 remaining on the trays diminishes. The automatic control system 50 can shut down the process when the weight of the remaining material reaches a point determined by the initial weight of the material 2 and the composition of the material. Thus, reaction time is determined as a result of the weight of the material 2.

The internal pressure of the processor 20 generally rises during the operation, but generally should remain less than 759 mm Hg absolute. During heating, the internal pressure may be from about 25.0 to about 759 mm Hg absolute, preferably about 316 to about 625 mm Hg absolute, more preferably about 366 to about 618 mm Hg absolute, even more preferably about 416 to about 568 mm Hg absolute.

As a result of the heating at subatmospheric pressures, the material 2 being treated dissociates into a vapor phase and a solid phase. For purposes of the present invention, “dissociate” is not limited to any particular chemical reaction or phenomenon.

The vapors are removed from the processor 20 during heating. In one exemplary embodiment, a collection manifold 24 comprising one or more pipes exit the processor 20 and lead to condensing means 26. In a further exemplary embodiment, the collection manifold 24 comprises seven pipes, four of which are evenly spaced 0.3 m above the vertical center of the processor 20, with the remaining three pipes evenly spaced 0.15 m above the floor of the processor 20.

Depending on the material being treated, at least some of the vapors being removed can be condensed to produce various types of condensate, which may include liquid hydrocarbons. In one exemplary embodiment, the collection manifold pipes 24 carry the vapor out of the processor into some means for cooling and condensing the vapors 26. The cooling means can be a cooling trough or a series of serpentine cooling tubes 27. In one embodiment, the serpentine cooling tubes are primarily horizontal although with a downward gradient. In another embodiment, the serpentine cooling tubes may be primarily vertical. The remaining vapor may then be carried through a second cooling means. At the end of the cooling means, the pipes enter a collection container 28 where the condensate is collected. The fuel may then be stored in a storage tank 18, 29, or other storage means. Pumps 31 may be used to move the fuel.

In one exemplary embodiment, the material being treated is rubber, and the condensate is liquid hydrocarbons comparable to #2 fuel oil. The liquid fuel has a low sulfur content. For purposes of the present invention, a “low sulfur content” for liquid hydrocarbons is less than 1.5 weight percent, preferably less than about 1.0 weight percent, more preferably less than 0.5 weight percent, and most preferably less than about 0.35 weight percent.

Approximately 70 to 90 weight percent of the vapors are typically condensed by means of the serpentine cooling tubes 27, although this amount may vary. Non-condensed vapors may pass through further condensation means, such as one or more condensation towers 30. In one exemplary embodiment, the remaining vapors pass through a series of two condensation towers, each with secondary condensation units at the top.

Any remaining non-condensed vapors exit the second condensation tower and are collected. The vapors may be compressed and stored in storage tanks 18, 29. The composition of these vapors depends on the composition of the material 2 being treated. In one exemplary embodiment, the material being treated is rubber, and the remaining vapor stream typically comprises methane with small amounts of propane and butane. A portion of these vapors, after compression, may be removed as a product fuel. A further portion of these vapors may be removed and recycled as a fuel source for the burner 14.

Following the completion of the reaction process, the processor is generally cooled. Cooling can be achieved by a variety of means, including the introduction of liquid nitrogen into the processor.

The racks 8 are then removed from the processor by conventional means, such as by a forklift or a winch. The composition of the solid phase remaining in the trays depends upon the material being treated, and can be stored or disposed of. In one exemplary embodiment, the material being treated is rubber, and the solid phase remaining in the trays generally contains a coke-like material. In another exemplary embodiment, the material being treated is derived from rubber tires, and the solid phase further contains metal along with the coke-like material. This mixture can be processed using techniques known in the art to separate the coke-like material from the steel.

In one exemplary embodiment, the solid phase comprising coke-like material and steel is processed by first removing the solid material directly from the racks 8 by means of a vacuum suction tube 32. The vacuum suction tube carries the material to a sealed chamber in a processing house 33. The solid material passes through a magnetic conveyor separator 34 to remove relatively large pieces of steel 35, and then to an enclosed magnetic roller 36 to remove steel particles as small as 100 microns. The resulting product 38 is a solid carbonaceous material, which can then be boxed for shipment. For purposes of the present invention, a “solid carbonaceous material” comprises activated carbon or carbon black. Activated carbon is defined as a carbonaceous material with improved absorptive properties. Carbon black is defined as any of various black substances, consisting chiefly of carbon, that is used especially in pigments.

In another exemplary embodiment, the solid carbonaceous material has a very low moisture content. Typically, the carbonaceous material will comprise from about 85 to about 93 weight percent carbon, from about 0.02 to 7 weight percent ash, and less than about 0.05 weight percent water. In a preferred embodiment, the solid carbonaceous material is activated carbon comprising 99.92 percent carbon, 0.02 percent ash, and 0.003 percent water. This may be achieved by a carbon wash, a technique known in the art. These percentages will vary depending upon operating conditions and the composition of the material treated.

Batches of material can be handled sequentially. In one exemplary embodiment, following the completion of the process, the racks are moved out of the processor incrementally one rack at a time. The solid phase component in the trays on the rack just removed from the processor is removed as described above, then the racks are incrementally moved out the equivalent of one more rack. While the solid phase component in the trays on the rack just removed from the processor is being removed as described above, new material 2 to be treated is loaded at the same time on the trays of the preceding rack, which are now empty. Thus, when the last rack in a sequence of racks has had the solid phase component removed, all preceding racks have already been loaded with new material 2, leaving only the final rack to be loaded before the racks can be reloaded into the processor. This method reduces the down time between processing cycles, and increases the efficiency and total production of the process.

As shown in FIG. 6, the processor 20 may also be in the form of a cylinder. A cylindrical processor 20 may be used for treating soil, plastics, liquids and similar substances. In one embodiment, an auger 40 or similar means is used for mixing or agitating the material inside the processor 20 during the heating process in order to improve reaction efficiency. The augur or mixing means may be driven by some motive means such as a motor 42. The material being treated is loaded into the processor 20 through a loading door 44 which typically is located on the top side of the processor 20, and the treated material removed through an unloading door 46 which typically is located on the bottom side of the processor 20. Accordingly, contaminated soil can be treated and rendered inert, or contaminated liquids can be purified.

In yet another exemplary embodiment of the invention, as shown in FIG. 4, semi-steady state operation may be achieved by cycling two processors 20, 60. Energy may also be conserved by using the waste heat from one processor 20 to pre-heat the second processor 60. In such an embodiment, the two processors 20, 60 will generally have the same dimensions. While a reaction is occurring in the first processor, the second processor is loaded and sealed. The exhaust heat from the first processor can be used to pre-heat the second processor.

In this embodiment, the first and second processors 20, 60 may be connected by a valved pressure equalization line 62. During the heating of the first processor 20, this line normally will closed by a valve 64. The valve typically will be an automatic valve 64, with a manual bypass valve 65. In one exemplary embodiment, when heating has stopped in the first processor 20, the internal pressure of the second processor is drawn approximately 457 mm Hg, resulting in an internal pressure in the second processor 60 of approximately 303 mm Hg absolute. The valve 64 is then opened to allow the pressure in both processors to equalize at about 505 mm Hg absolute. This results in heat passing from the first processor to the second processor, conserving energy. The burner for the second processor 60 is ignited and heating begins in the second processor. The treating process in the second processor proceeds as described above for the embodiment comprising a single processor.

The raw material for the process of the present invention will be any material, such as plastics, that can be separated into its organic and inorganic components. As disclosed in the prior art, such materials also may include rubber and rubber tires. Examples of the composition of such materials, the products that can be produced by heating rubber and rubber tires, and the uses of such products, are presented in Jarrell, U.S. Pat. No. 5,230,777. The specification of Jarrell, U.S. Pat. No. 5,230,777, is incorporated herein in its entirety. Rubber and rubber tires can be treated by the present invention in a similar fashion. There are significant advantages of the present invention over the prior art in treating rubber and rubber tires, however, including increased energy efficiency in using a single burner with a radiant tube, reduced heating times, more efficient cooling, more efficient loading and unloading, more precise determination of the effective heating time for a particular batch of material, reduced air pollution emissions, and cleaner end products.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. An apparatus for treating a material to separate it into its organic and inorganic components, comprising:
a. at least one processor for receiving and holding the material;
b. means for heating the processor to an internal temperature of at least 100 degrees F.;
c. means for reducing the internal pressure in the processor, whereby the material is separated into organic and inorganic components;
d. means for removing the organic components from the processor and delivering them to condensing means;
e. means for condensing at least a portion of the organic components removed from the processor; and
f. means for removing the inorganic components from the processor and delivering the inorganic components to processing means.

2. The apparatus of claim 1, wherein the heating means comprises a burner providing heat to a radiant tube located inside the sealed processor.

3. The apparatus of claim 2, further wherein the radiant tube is serpentine in form.

4. The apparatus of claim 3, further wherein the radiant tube is at least nine feet in length.

5. The apparatus of claim 1, wherein the condensing means comprises at least one cooling tube or cooling trough.

6. The apparatus of claim 5, further wherein the cooling tube is serpentine in form.

7. The apparatus of claim 1, further comprising one or more racks for holding said materials in said processor on one or more trays.

8. The apparatus of claim 7, further wherein each rack has two or more wheels.

9. The apparatus of claim 8, further wherein two or more racks are connected to each other in sequence.

10. The apparatus of claim 7, further wherein each rack is moved into and out of the processor by motive means.

11. The apparatus of claim 10, wherein said motive means comprises one or more winches.

12. The apparatus of claim 1, further comprising means for continuous weighing of the material.

13. The apparatus of claim 12, wherein said weighing means comprising one or more scales that weigh the process and all contents, including the material.

14. The apparatus of claim 12, further comprising a control system to terminate the heating process when the weight of the materials reaches a predetermined weight.

15. The apparatus of claim 1, further comprising a second sealed processor, means for heating the second processor, means for reducing the pressure in the second processor, means for removing organic components from the second processor and condensing said organic components, and means for removing the inorganic components from the second processor and processing said inorganic components.

16. The apparatus of claim 15 further comprising valved pressure equalization means capable of equalizing the pressure between the two sealed processors.

17. The apparatus of claim 16, further wherein the valved pressure equalization means comprises a valved pipe running between the two sealed processors that allows pressure equalization between the two processors when the valve is open and thereby allows heat to pass from one processor to the other processor.

18. The apparatus of claim 1, further comprising means for delivering at least some of the remaining gaseous organic component to the heating means to serve as fuel for the heating means.

19. The apparatus of claim 1, wherein said processor is rectangular.

20. The apparatus of claim 1, wherein said processor is cylindrical.

21. The apparatus of claim 20, further comprising means for agitating or mixing the material inside the cylindrical processor.

22. The apparatus of claim 21, wherein said agitation means comprises an auger.

23. The apparatus of claim 1, wherein the material comprises plastic or soil.

24. The apparatus of claim 1, wherein the material comprises rubber.

25. The apparatus of claim 1, wherein the material comprises rubber tires or pieces of rubber tires.

26. The apparatus of claim 1, wherein the processor is insulated.

27. The apparatus of claim 1, further comprising means for controlling the amount of heat applied to the material during the treating process.

28. The apparatus of claim 1, wherein said processor is capable of reaching an internal temperature of from about 100 to about 1000 degrees F. and negative pressures of from about 25.0 to about 759 mm Hg absolute with zero or minimal amounts of air leakage.

29. A process for treating a material, comprising the steps of:
a. moving the material into at least one processor capable of reaching an internal temperature of at least 100 degrees F.;
b. heating the material in the processor to a temperature inside the processor of at least 100 degrees F. for a predetermined time under an internal negative pressure of at least 25.0 mm Hg absolute, whereby the material is separated into organic and inorganic components;
c. removing the organic components from the processor and delivering the organic components to condensing means, whereby at least some of the organic components are condensed into liquid form; and
d. removing the inorganic components from the processor and delivering the inorganic components to processing means, whereby the inorganic components are converted into a solid form.

30. The process of claim 29, wherein the processor is sealed to provide an internal pressure of from about 25.0 to about 759 mm Hg absolute with zero or minimal amounts of air leakage.

31. The process of claim 29, wherein the processor is capable of reaching an internal temperature of from 100 degrees F. to 1000 degrees F.
